(19) United States
(12) Patent Application Publication
(10) Pub. No.: US 2025/0088789 A1
(43) Pub. Date: Mar. 13, 2025

(54) LOUDSPEAKERS

(71) Applicant: SHENZHEN SHOKZ CO., LTD., Shenzhen (CN)

(72) Inventors: Wenbing ZHOU, Shenzhen (CN); Lei ZHANG, Shenzhen (CN); Xin QI, Shenzhen (CN); Fengyun LIAO, Shenzhen (CN); Shanyong GU, Beijing (CN)

(73) Assignee: SHENZHEN SHOKZ CO., LTD., Shenzhen (CN)

(21) Appl. No.: 18/959,554

(22) Filed: Nov. 25, 2024

Related U.S. Application Data
(63) Continuation of application No. PCT/CN2022/128249, filed on Oct. 28, 2022.

(51) Int. Cl. H04R 1/28

(52) U.S. Cl. CPC H04R 1/28

(57) ABSTRACT

Disclosed is a loudspeaker, comprising a vibration diaphragm configured to vibrate to generate air-conducted sound waves and a casing configured to form an accommodation cavity. The vibration diaphragm divides the accommodation cavity into a front cavity and a rear cavity, the casing being provided with a sound outlet hole in flow communication with the front cavity, and at least a portion of the air-conducted sound waves being transmitted to the outside of the loudspeaker via the sound outlet hole. The casing is provided with a sound absorption pipe, and the sound absorption pipe is in flow communication with at least one of the front cavity and the rear cavity and configured to absorb sound waves of a target frequency in the air-conducted sound waves, and a length of the sound absorption pipe being in a range of 3/20-2/5 of a wavelength of the sound waves of the target frequency.

### CROSS-REFERENCE TO RELATED APPLICATIONS

This application is a Continuation of International Patent Application No. PCT/CN2022/128249, filed on Oct. 28, 2022, the entire contents of which are incorporated herein by reference.

### TECHNICAL FIELD

The present disclosure relates to the field of acoustic devices, and in particular, to a loudspeaker whose casing is provided with a sound absorption pipe.

### BACKGROUND

With the continuous development of electronic devices, loudspeakers (e.g., earphones) have become indispensable tools for social interaction and entertainment in people's daily lives, and people's requirements for loudspeakers are getting higher and higher. However, existing loudspeakers still have many problems, such as complex structures and poor sound quality. Therefore, it is desirable to provide a loudspeaker with a simple structure and high acoustic performance to meet the needs of users.

### SUMMARY

One of the embodiments of the present disclosure provides a loudspeaker comprising: a vibration diaphragm, configured to vibrate to generate air-conducted sound waves; and a casing, configured to form an accommodation cavity to accommodate the vibration diaphragm, the vibration diaphragm dividing the accommodation cavity into a front cavity and a rear cavity, the casing being provided with a sound outlet hole in flow communication with the front cavity, and at least a portion of the air-conducted sound waves being transmitted to the outside of the loudspeaker via the sound outlet hole. The casing is provided with a sound absorption pipe, and the sound absorption pipe is in flow communication with at least one of the front cavity and the rear cavity and configured to absorb sound waves of a target frequency in the air-conducted sound waves, a length of the sound absorption pipe being in a range of 3/20-2/5 of a wavelength of the sound waves of the target frequency.

In some embodiments, the vibration of the vibration diaphragm has an original resonance frequency, and a difference between the original resonance frequency and the target frequency is within 300 Hz.

In some embodiments, the target frequency is in a range of 3 kHz to 20 KHz.

In some embodiments, the front cavity is in flow communication with the sound outlet hole through a sound guiding channel, and the sound absorption pipe is in flow communication with the sound guiding channel through the front cavity.

In some embodiments, the casing includes a front cavity plate, a rear cavity plate, and a side plate, and an end of the sound absorption pipe includes a sound inlet hole.

In some embodiments, the loudspeaker further includes a driving unit configured to generate vibration based on an electrical signal and drive the vibration diaphragm to vibrate. The driving unit is provided in the rear cavity and cooperates with the rear cavity plate to divide the rear cavity into a first rear cavity and a second rear cavity, the second rear cavity being enclosed by the driving unit and the rear cavity plate.

In some embodiments, the sound absorption pipe is provided in the rear cavity plate and in flow communication with the first rear cavity via the sound inlet hole.

In some embodiments, the sound absorption pipe is provided in the front cavity plate and in flow communication with the front cavity via the sound inlet hole.

In some embodiments, the other end of the sound absorption pipe is closed.

In some embodiments, the sound inlet hole is located within a projection of the vibration diaphragm along a vibration direction of the vibration diaphragm.

In some embodiments, the vibration diaphragm includes a folded-ring portion and a fixed end, and the sound inlet hole faces the folded-ring portion.

In some embodiments, a projection of the sound absorption pipe along a vibration direction of the vibration diaphragm includes a loop structure or a folded structure.

In some embodiments, the loudspeaker further includes a driving unit, and on a projection plane along a vibration direction of the driving unit, the loop structure is disposed around the driving unit.

In some embodiments, the sound absorption pipe includes sub-sound absorption pipes, and each of the sub-sound absorption pipes is in flow communication with the front cavity or the rear cavity via a sound inlet hole.

In some embodiments, the sub-sound absorption pipes are symmetrically disposed along a central axis of the loudspeaker.

In some embodiments, at least two of the sub-sound absorption pipes absorb sound waves of a same frequency or different frequencies in the air-conducted sound waves.

In some embodiments, an equivalent length of the sound absorption pipe is in a range of 4 mm to 28 mm.

In some embodiments, an equivalent diameter of the sound absorption pipe is not less than 0.05 mm.

In some embodiments, the front cavity is in flow communication with the sound outlet hole through a sound guiding channel, and the sound absorption pipe is provided on a side wall of the sound guiding channel and is in flow communication with the sound guiding channel via a sound inlet hole provided at one end of the sound absorption pipe.

In some embodiments, the sound absorption pipe includes a 1/4 wavelength resonance tube.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, where:

FIG. 1 is a block diagram illustrating a loudspeaker according to some embodiments of the present disclosure;

FIG. 2 is a schematic diagram illustrating an exemplary structure of a sound absorption pipe according to some embodiments of the present specification;

FIG. 3 is a schematic diagram illustrating an exemplary structure of a loudspeaker according to some embodiments of the present disclosure;

FIG. 4 is a schematic diagram illustrating frequency response curves of a loudspeaker according to some embodiments of the present disclosure;

FIG. 5 is a schematic diagram illustrating frequency response curves of a loudspeaker according to some other embodiments of the present disclosure;

FIG. 6A is a schematic diagram illustrating an exemplary three-dimensional structure of a sound absorption pipe according to some embodiments of the present disclosure;

FIG. 6B is a schematic diagram illustrating a cross-section of the sound absorption pipe in FIG. 6A along A-A according to some embodiments of the present disclosure;

FIG. 6C is a schematic diagram illustrating a cross-section of the sound absorption pipe in FIG. 6A along A-A according to some other embodiments of the present disclosure;

FIG. 7A is a schematic diagram illustrating an exemplary three-dimensional structure of a sound absorption pipe according to some embodiments of the present disclosure;

FIG. 7B is a schematic diagram illustrating a cross-section of the sound absorption pipe in FIG. 7A along B-B according to some embodiments of the present disclosure;

FIG. 7C is a schematic diagram illustrating a cross-section of the sound absorption pipe in FIG. 7A along B-B according to some other embodiment of the present disclosure;

FIG. 7D is a schematic diagram illustrating a cross-section of the sound absorption pipe in FIG. 7A along B-B according to some other embodiments of the present disclosure;

FIG. 7E is a schematic diagram illustrating a cross-section of the sound absorption pipe in FIG. 7A along B-B according to some other embodiments of the present disclosure;

FIG. 8A is a schematic diagram illustrating an exemplary structure of a loudspeaker according to some embodiments of the present disclosure;

FIG. 8B is a schematic diagram illustrating a cross-section of the sound absorption pipe in FIG. 8A along A-A according to some embodiments of the present disclosure;

FIG. 9A is a schematic diagram illustrating an exemplary structure of a loudspeaker according to some other embodiments of the present disclosure;

FIG. 9B is a schematic diagram illustrating a cross-section of the sound absorption pipe in FIG. 9A along A-A according to some embodiments of the present disclosure;

FIG. 10A is a schematic diagram illustrating an exemplary structure of a loudspeaker according to some other embodiments of the present disclosure;

FIG. 10B is a schematic diagram illustrating a cross-section of the sound absorption pipe in FIG. 10A along A-A according to some embodiments of the present disclosure;

FIG. 11A is a schematic diagram illustrating an exemplary structure of a loudspeaker according to some embodiments of the present disclosure;

FIG. 11B is a schematic diagram illustrating a cross-section of the sound absorption pipe in FIG. 11A along A-A according to some embodiments of the present disclosure; and

FIG. 12 is a schematic diagram illustrating an exemplary structure of a loudspeaker according to some embodiments of the present disclosure.

### DETAILED DESCRIPTION

In order to more clearly illustrate the technical solutions of the embodiments of the present disclosure, the following will briefly introduce the accompanying drawings that need to be used in the description of the embodiments. Obviously, the accompanying drawings in the following description are only some examples or embodiments of the present disclosure, and it is possible for a person of ordinary skill in the art to apply the present disclosure to other similar scenarios based on the accompanying drawings without creative labor. Unless obviously obtained from the context or the context illustrates otherwise, the same numeral in the drawings refers to the same structure or operation.

It should be understood that as used herein, the terms “system,” “device,” “unit” and/or “module” as used herein is a way to distinguish between different components, elements, parts, sections, or assemblies at different levels. However, the terms may be replaced by other expressions if other words accomplish the same purpose.

As used in the disclosure and the appended claims, the singular forms “a,” “an,” and “the” include plural referents unless the content clearly dictates otherwise. In general, the terms “including” and “comprising” suggest only the inclusion of clearly identified steps and elements, which do not constitute an exclusive list, and the method or device may also include other steps or elements. The term “based on” is “based at least in part on;” the term “one embodiment” means “at least one embodiment;” and the term “another embodiment” means “at least one other embodiment.”

In the description of the present disclosure, it is to be understood that the terms “first,” “second,” “third,” and “fourth,” etc. are used for descriptive purposes only, and are not to be understood as indicating or implying relative importance or implicitly specifying the number of technical features indicated. Thereby, the limitations “first,” “second,” “third,” and “fourth” may expressly or implicitly include at least one such feature. In the description of the present disclosure, “plurality” means at least two, e.g., two, three, or the like, unless explicitly and specifically limited otherwise.

In the present disclosure, unless otherwise expressly specified or limited, the terms “connection,” “fixation,” etc. shall be broadly construed unless otherwise expressly provided and qualified. For example, the term “connection” refers to a fixed connection, a removable connection, or a one-piece connection; a mechanical connection, or an electrical connection; a direct connection, or an indirect connection through an intermediate medium, a connection within two elements, or an interaction between two elements, unless expressly limited otherwise. To one of ordinary skill in the art, the specific meanings of the above terms in the present disclosure may be understood on a case-by-case basis.

Embodiments of the present disclosure provide a loudspeaker comprising a vibration diaphragm, a casing, and a sound absorption pipe. The vibration diaphragm may vibrate to generate air-conducted sound waves. The casing may form an accommodation cavity to accommodate the vibration diaphragm. The vibration diaphragm divides the accommodation cavity into a front cavity and a rear cavity. The casing is provided with a sound outlet hole in flow communication with the front cavity, and at least a portion of the air-conducted sound waves is transmitted to the outside of the loudspeaker via the sound outlet hole. The casing is provided with the sound absorption pipe. The sound absorption pipe is in flow communication with at least one of the front cavity and the rear cavity and configured to absorb sound waves of a target frequency in the air-conducted sound waves. In some embodiments, by providing the sound absorption pipe in the casing, the sound absorption pipe is in flow communication with at least one of the front cavity and the rear cavity and configured to absorb the sound waves of a target frequency in the air-conducted sound waves, thereby making a frequency response curve of the loudspeaker flatter and improving the acoustic performance of the loudspeaker. Additionally, the vibration state of the vibration diaphragm in the loudspeaker can be affected by the sound absorption pipe, thereby adjusting the frequency response curve of the loudspeaker and making the loudspeaker have a built-in structural filtering effect.

The loudspeaker provided by the embodiments of the present disclosure is described in detail below in connection with the accompanying drawings.

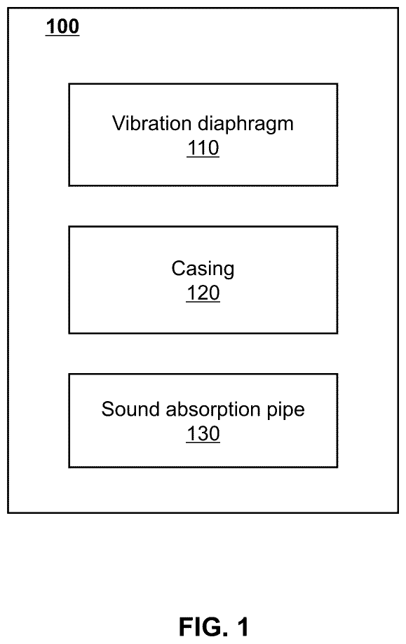

FIG. 1 is a block diagram illustrating a loudspeaker according to some embodiments of the present disclosure. As shown in FIG. 1, a loudspeaker 100 includes a vibration diaphragm 110, a casing 120, and a sound absorption pipe 130.

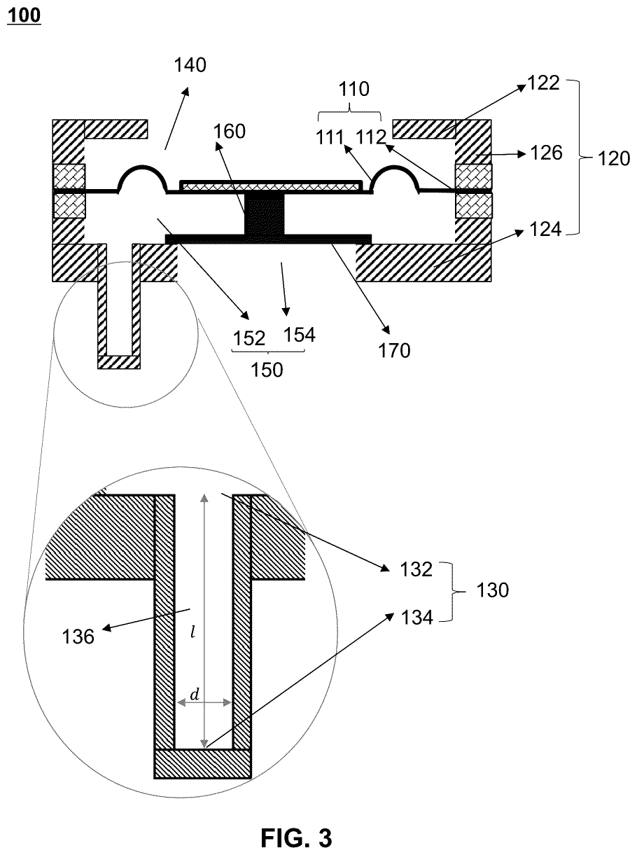

The vibration diaphragm 110 vibrates to generate air-conducted sound waves. In some embodiments, the vibration diaphragm 110 may directly receive an electrical signal and convert the electrical signal into a vibration signal. For example, the vibration diaphragm 110 may include a piezoelectric vibration diaphragm, an electrostatically-driven vibration diaphragm, or the like. In other words, in some embodiments, the vibration diaphragm 110 is also a driving unit. In some embodiments, the loudspeaker 100 may include a driving unit (e.g., a driving unit 170 in FIG. 3). The driving unit may receive the electrical signal and convert the electrical signal into the vibration signal. The driving unit may transmit the vibration signal, for example, to the vibration diaphragm 110 via a vibration transmission unit, thereby driving the vibration diaphragm 110 to vibrate. In some embodiments, the driving unit may include a moving coil driving unit, a moving iron driving unit, an electrostatic driving unit, a piezoelectric driving unit, or the like. For ease of description, the present disclosure will be described in terms of the vibration diaphragm being independently disposed with respect to the driving unit, which does not limit the scope of the present disclosure.

The casing 120 may form an accommodation cavity to accommodate other components of the loudspeaker 100 (e.g., the vibration diaphragm 110, the driving unit, etc.). The vibration diaphragm 110 may divide the accommodation cavity into a front cavity and a rear cavity. The casing 120 may be provided with a sound outlet hole in flow communication with the front cavity. At least a portion of the air-conducted sound waves generated by the vibration of the vibration diaphragm 110 may be transmitted to the outside of the loudspeaker 100 via the sound outlet hole.

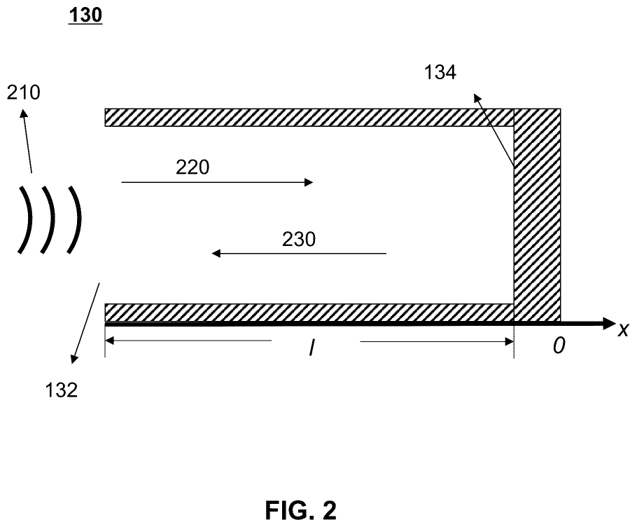

The casing 120 may be provided with the sound absorption pipe 130. The sound absorption pipe is in flow communication with at least one of the front cavity and the rear cavity, and the sound absorption pipe is configured to absorb sound waves of a target frequency in the air-conducted sound waves. In other words, the sound absorption pipe 130 may have a sound absorption effect. More description of the sound absorption pipe 130 may be found elsewhere in the present disclosure (e.g., FIGS. 2-5, FIG. 6A to FIG. 12, etc., and descriptions thereof).

FIG. 2 is a schematic diagram illustrating an exemplary structure of a sound absorption pipe according to some embodiments of the present disclosure. As shown in FIG. 2, the sound absorption pipe 130 may include a sound wave reflection surface 134 and a sound inlet hole 132. Incident sound waves 220 from a sound source 210 may enter the sound absorption pipe 130 via the sound inlet hole 132 and propagate along a positive x-axis direction within the sound absorption pipe 130. Furthermore, the incident sound waves 220 are reflected upon reaching the sound wave reflection surface 134, then reflected sound waves 230 are formed, where a direction of the reflected sound waves 230 is opposite to a direction of the incident sound waves 220.

According to FIG. 2, defining a position of the sound wave reflection surface 134 to be an origin O of the x-axis, a sound pressure Pᵢ of the incident sound waves 220 and a sound pressure Pᵣ of the reflected sound waves 230 may be expressed as follows, respectively:

$${P}_{i} = {P}_{ai} {e}^{j ( ω t - kx )} \qquad ( 1 )$$

$${P}_{r} = {P}_{ar} {e}^{j ( ω t + kx )} \qquad ( 2 )$$

where Pₐᵢ denotes a sound pressure amplitude of the incident sound waves 220, Pₐᵣ denotes a sound pressure amplitude of the reflected sound waves 230, ω denotes an angular frequency of vibration, t denotes a time, k denotes a wave number, and x denotes the coordinates of sound waves on the x-axis.

According to Equation (1) and Equation (2), a total sound pressure P inside the sound absorption pipe 130 may be expressed as:

$$P = {P}_{r} + {P}_{i} = \vert P \vert {e}^{J ( ω t + φ )} \qquad ( 3 )$$

where φ denotes a phase introduced, |P| denotes a total sound pressure amplitude of the incident sound waves 220 and the reflected sound waves 230, and |P| may be expressed as:

$$\vert P \vert = {P}_{ai} \vert \sqrt{1 + {\vert {r}_{p} \vert}^{2} + 2 \vert {r}_{p} \vert cos 2 k ( x + σ \frac{λ}{4} )} \vert \qquad ( 4 )$$

where rₚ denotes a sound pressure reflection coefficient, σπ denotes a phase difference between the reflected sound waves 230 and the incident sound waves 220 on the sound wave reflection surface 134, and λ denotes a wavelength of sound waves.

According to Equation (4), the total sound pressure amplitude |P| reaches a minimum value when

$$cos 2 k ( x + σ \frac{λ}{4} ) = - 1 ,$$

at which time

$$x = - ( 1 + σ \frac{λ}{4} ) .$$

That is, the total sound pressure amplitude in the sound absorption pipe 130 is minimal at a distance of

$$( 1 + σ \frac{λ}{4} )$$

from the sound wave reflection surface 134. In some embodiments, the sound wave reflection surface 134 may be a rigid reflection surface that reflects the incident sound waves 220 entirely. Correspondingly, the sound pressure reflection coefficient rₚ=1 and σ=0, and at this time,

$$x = - \frac{λ}{4} .$$

Thus, at a position with a distance

$$/= \frac{λ}{4} ,$$

from the sound wave reflection surface 134 in the sound absorption pipe 130, the total sound pressure amplitude reaches a minimum value. Therefore, by setting an equivalent length/of the sound absorption pipe 130, for example, when

$$\frac{λ}{4}$$

a sound pressure amplitude at the sound inlet hole 132 of the sound absorption pipe 130 reaches a minimum value, such that the sound absorption pipe 130 absorbs sound waves of the target frequency (i.e., the wavelength λ). In some embodiments, the sound absorption pipe 130 may include a 1/4 wavelength resonance tube.

FIG. 3 is a schematic diagram illustrating an exemplary structure of a loudspeaker according to some embodiments of the present disclosure.

As shown in FIG. 3, the loudspeaker 100 may include the vibration diaphragm 110, the casing 120, the sound absorption pipe 130, a front cavity 140, a rear cavity 150, a vibration transmission unit 160, and a driving unit 170. The casing 120 may form an accommodation cavity to accommodate one or more components of the loudspeaker 100 (e.g., the vibration diaphragm 110, the driving unit 170, etc.). The vibration diaphragm 110 may include a folded-ring portion 111 and a fixed end 112. The vibration diaphragm 110 is connected with the casing 120 through the fixed end 112 and divides the accommodation cavity into the front cavity 140 and the rear cavity 150. The driving unit 170 may perform an energy conversion to convert electrical energy (i.e., an electrical signal) into mechanical energy (i.e., a vibration signal) and transmit generated mechanical energy to the vibration diaphragm 110 through the vibration transmission unit 160. The vibration diaphragm 110 may vibrate under the drive of the driving unit 170 and push the air to generate air-conducted sound waves. At least a portion of the air-conducted sound waves may be transmitted to the outside of the loudspeaker 100 via a sound outlet hole (not shown in the figures).

In some embodiments, the casing 120 may include a front cavity plate 122, a rear cavity plate 124, and a side plate 126. The front cavity plate 122, the rear cavity plate 124, and the side plate 126 enclose the accommodation cavity. In some embodiments, the front cavity plate 122, the rear cavity plate 124, and/or the side plate 126 may include a printed circuit board (PCB) plate, a plastic plate, a metal plate, or the like, which is not limited in the present disclosure.

In some embodiments, the driving unit 170 may be provided in the rear cavity 150. In some embodiments, the rear cavity 150 may or may not be divided by setting an arrangement position of the driving unit 170. For example, for a piezoelectric loudspeaker, the driving unit 170 may be secured to the casing 120 (e.g., the rear cavity plate 124) through a bracket with holes, thereby not dividing the rear cavity 150. As another example, for an electromagnetic loudspeaker, a magnetic circuit portion of the loudspeaker (i.e., the driving unit 170) may be secured to the casing 120 (e.g., the rear cavity plate 124) through a bracket with holes, thereby not dividing the rear cavity 150. As a further example, as shown in FIG. 3, the driving unit 170 may be fixed to the rear cavity plate 124 and cooperate with the rear cavity plate 124 to divide the rear cavity 150 into a first rear cavity 152 and a second rear cavity 154. The first rear cavity 152 may be enclosed by at least a portion of the casing 120, at least a portion of the vibration diaphragm 110, the driving unit 170, and the vibration transmission unit 160. The second rear cavity 154 may be enclosed by the driving unit 170 and the rear cavity plate 124. The second rear cavity 154 may or may not be in flow communication with the outside of the loudspeaker 100. For description, the present disclosure will take an arrangement in which the driving unit 170 divides the rear cavity 150 as an example, which does not limit the scope of the present disclosure.

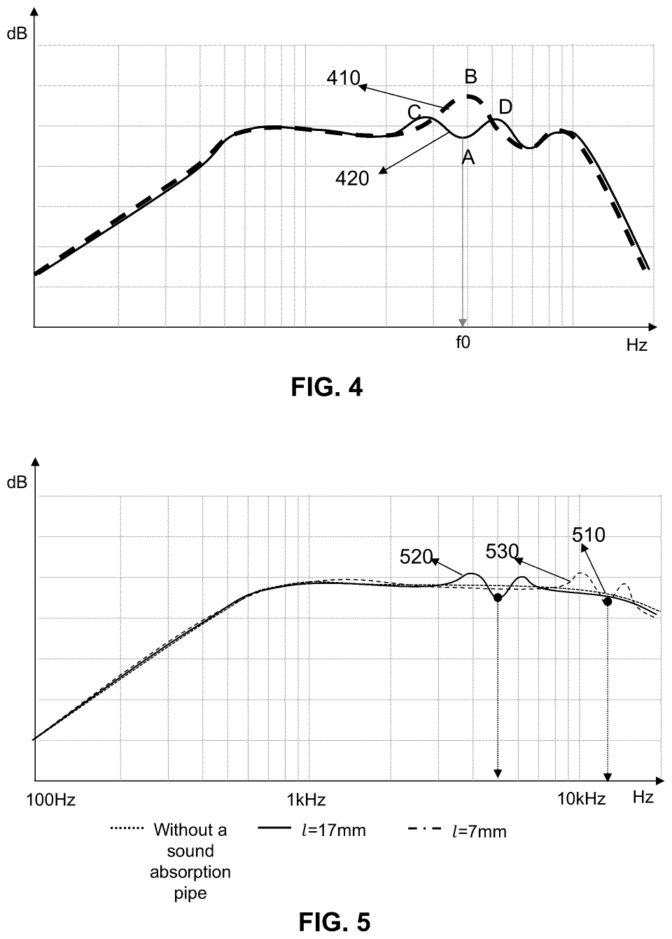

One end of the sound absorption pipe 130 may include the sound inlet hole 132, and the other end of the sound absorption pipe is closed to form the sound wave reflection surface 134. In some embodiments, the sound absorption pipe 130 may be provided on the front cavity plate 122, the rear cavity plate 124, the side plate 126, or the like. For example, the sound absorption pipe 130 may be provided on the rear cavity plate 124 and is in flow communication with the first rear cavity 152 via the sound inlet hole 132, as shown in FIG. 3. In some embodiments, the sound absorption pipe 130 may be configured to absorb sound waves of a target frequency in the air-conducted sound waves generated by the vibration diaphragm 110, thereby adjusting a frequency response curve of the loudspeaker 100. For example, the sound absorption pipe 130 may absorb the sound waves of a target frequency in the air-conducted sound waves, so that a component of sound waves of the target frequency in sound waves outputted outwardly by the loudspeaker 100 is reduced, and correspondingly, a sound pressure of the sound waves outputted by the loudspeaker 100 is reduced near the target frequency, which appears as a trough (such as a trough A in a curve 420 shown in FIG. 4) in the frequency response curve, so as to adjust the frequency response curve of the loudspeaker 100.

In some embodiments, adjustment of the frequency response curve of the loudspeaker 100 may be achieved by adjusting one or more parameters (e.g., shape, position, size, etc.) of the sound absorption pipe 130. For example, in conjunction with FIG. 2 and the description thereof, when the equivalent length of the sound absorption pipe l is

$$\frac{λ}{4} ,$$

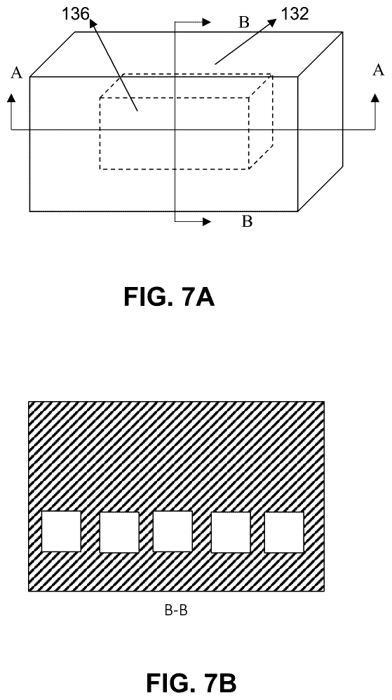

a sound pressure amplitude of sound waves of a target frequency of a wavelength λ is minimal at the sound inlet hole 132, and the sound absorption pipe 130 may absorb the sound waves of the target frequency, so that the frequency response curve of the loudspeaker 100 has a trough near the target frequency. Therefore, a target frequency (e.g., where the trough is located) of sound waves absorbed by the sound absorption pipe 130 may be adjusted by adjusting the equivalent length of the sound absorption pipe to be l, so as to realize troughs in different frequency bands on the frequency response curve of the loudspeaker 100, enabling the loudspeaker 100 to meet the actual demand and improving the user experience. In some embodiments, the equivalent length l of the sound absorption pipe 130 may be near 1/4 of the wavelength λ of the sound waves of a target frequency. For example, the equivalent length/of the sound absorption pipe 130 may be in a range of 1/10-2/5 of the wavelength λ of the sound waves of the target frequency. As another example, the equivalent length l of the sound absorption pipe 130 may be in a range of 3/20-2/5 of the wavelength l of the sound waves of a target frequency. As another example, the equivalent length l of the sound absorption pipe 130 may be in a range of 1/5-3/10 of the wavelength λ of the sound waves of a target frequency. In some embodiments, an equivalent diameter d of the sound absorption pipe 130 affects the sound resistance of the sound absorption pipe 130, thus affecting the troughs formed on the frequency response curve of the loudspeaker 100. For example, a value of d that is too small may result in a high sound resistance, rendering the sound absorption pipe 130 ineffective at absorbing sound. In some embodiments, to ensure that the sound absorption pipe 130 has a sound absorption effect, the equivalent diameter d of the sound absorption pipe 130 may be no less than 0.05 mm. For example, the equivalent diameter d of the sound absorption pipe 130 may be no less than 0.3 mm. As another example, the equivalent diameter d of the sound absorption pipe 130 may be no less than 0.1 mm. More descriptions of the sound absorption pipe 130 may be found in FIG. 6A to FIG. 12 and descriptions thereof in the present disclosure, which will not be repeated herein.

FIG. 4 is a schematic diagram illustrating exemplary frequency response curves of a loudspeaker according to some embodiments of the present disclosure.

As shown in FIG. 4, a curve 410 represents a frequency response curve of a loudspeaker without a sound absorption pipe, and a curve 420 represents a frequency response curve of a loudspeaker (e.g., the loudspeaker 100) with a sound absorption pipe.

According to FIG. 4, for the loudspeaker without the sound absorption pipe, the vibration of a vibration diaphragm may have a corresponding resonance frequency (corresponding to a frequency corresponding to a resonance peak B of the frequency response curve 410). Resonance frequencies of vibration of the vibration diaphragm result in the frequency response curve of the loudspeaker without the sound absorption pipe being less flat. A sound absorption pipe (e.g., the absorption pipe 130) may be provided on a casing of the loudspeaker (e.g., the front cavity plate 122, the rear cavity plate 124, and other positions of the casing 120). Due to the sound absorption effect of the sound absorption pipe on sound waves of a target frequency, the response of the frequency response curve of the loudspeaker at the target frequency is effectively reduced. As shown in FIG. 4, a sound absorption frequency (i.e., the target frequency) of the sound absorption pipe is set the same as the resonance frequency of the vibration diaphragm, which can effectively inhibit a peak value of the vibration of the vibration diaphragm at the target frequency, and even make the overall frequency response curve of the loudspeaker to have a trough at the resonance frequency of the vibration of the vibration diaphragm.

For example, for a loudspeaker with a sound absorption pipe, the vibration of the vibration diaphragm may have an original resonance frequency (which may be approximated as a frequency of the resonance peak B in the frequency response curve 410). In some embodiments, by designing parameters of the sound absorption pipe (such as shape, position, size, etc.), the target frequency corresponding to the sound absorption pipe may be near the original resonance frequency of the vibration of the vibration diaphragm, which can significantly reduce a peak value of the loudspeaker with the sound absorption pipe at the original resonance frequency, thereby forming a trough and two peaks on either side of the trough (for example, peaks C and D in FIG. 4, where amplitudes of both the peaks C and D are less than that of the resonance peak B, and an amplitude difference between the peak C or the peak D and the resonance peak B may be greater than 6 dB, while an amplitude difference between the trough A and the resonance peak B may be greater than 12 dB), thereby enhancing the overall sensitivity of the loudspeaker and making the frequency response curve flatter. In some embodiments, a difference between the target frequency and the original resonance frequency may be in a range of 300 Hz. In some embodiments, the difference between the target frequency and the original resonance frequency may be in a range of 200 Hz. In some embodiments, the difference between the target frequency and the original resonance frequency may be in a range of 100 Hz. In some embodiments, the target frequency may be equal to the original resonance frequency.

In some embodiments, a frequency response curve of a loudspeaker is relatively smooth in a low-to-mid frequency range, while in a mid-to-high frequency range, high-order modes of a vibration diaphragm and a driving unit of the loudspeaker, as well as modes of a sound absorption pipe, multiple resonance peaks may be generated. Therefore, to obtain a smoother frequency response curve in the mid-to-high frequency range, the sound absorption pipe may be configured so that the target frequency is within the mid-to-high frequency range. In some embodiments, the target frequency may be in a range of 1 kHz to 20 KHz. Correspondingly, an equivalent length of the sound absorption pipe may be in a range of 4 mm to 80 mm. In some embodiments, the target frequency may be in a range of 3 kHz to 20 KHz. Correspondingly, the equivalent length of the sound absorption pipe may be in a range of 4 mm to 28 mm. In some embodiments, the target frequency may be in a range of 3 KHz to 10 KHz. Correspondingly, the equivalent length of the sound absorption pipe may be in a range of 8 mm to 28 mm. In some embodiments, the target frequency may be in a range of 1.2 kHz to 8 KHz. Correspondingly, the equivalent length of the sound absorption pipe may be in a range of 10 mm to 70 mm.

As shown in FIG. 4, the frequency response curve of the loudspeaker with the sound absorption pipe is flatter than the frequency response curve of the loudspeaker without the sound absorption pipe, which results in a better acoustic effect of the loudspeaker. In some embodiments, a depth of the trough may be further adjusted by adjusting a damping of one or more components of the loudspeaker (e.g., the sound absorption pipe 130) to flatten the frequency response curve of the loudspeaker, thereby further improving the acoustic effect of the loudspeaker.

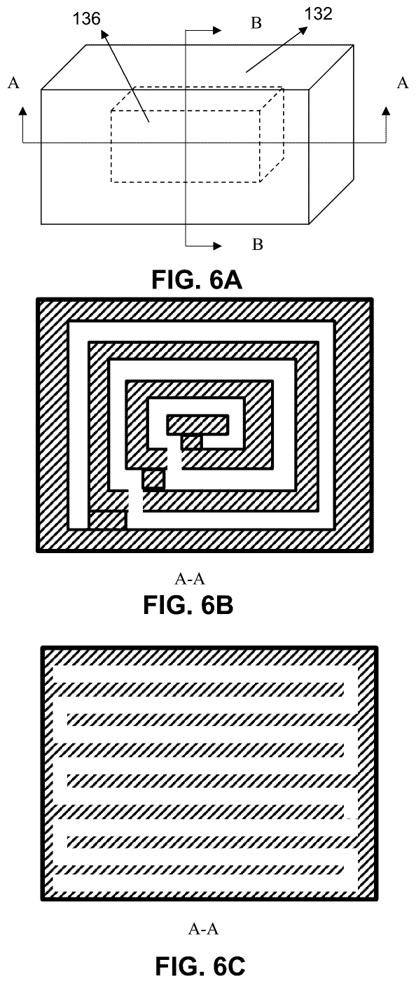

FIG. 5 is a schematic diagram illustrating exemplary frequency response curves of a loudspeaker according to some other embodiments of the present disclosure. As shown in FIG. 5, a curve 510 represents a frequency response curve of a loudspeaker without a sound absorption pipe. A curve 520 represents a frequency response curve of a loudspeaker with a sound absorption pipe with an equivalent length/of 17 mm. A curve 530 represents a frequency response curve of a loudspeaker with a sound absorption pipe with an equivalent length l of 7 mm. According to FIG. 5, by providing the sound absorption pipe (corresponding to the curve 520 or the curve 530) in a casing of the loudspeaker, a trough is formed at a specific frequency (e.g., in a frequency band between 5 kHz and 12 kHz), and two peaks are formed on the left and the right of the trough, which improves the sensitivity of the loudspeaker. Further, by adjusting the equivalent length/of the sound absorption pipe, the trough (or a target frequency) may be at a different position, realizing the sound absorption effect on sound waves of different target frequencies.

FIG. 6A is a schematic diagram illustrating an exemplary three-dimensional structure of a sound absorption pipe according to some embodiments of the present disclosure. FIG. 6B and FIG. 6C are schematic diagrams illustrating cross-sections of the sound absorption pipe in FIG. 6A along A-A.

In some embodiments, the sound absorption pipe 130 may include a sound absorption cavity 136 and a sound inlet hole 132, as shown in FIG. 6A. A dimension (e.g., the equivalent length l of the sound absorption pipe 130 and the equivalent diameter d of the sound absorption pipe 130), a shape, etc., of the sound absorption pipe 130 may be configured to absorb sound waves of different target frequencies, thereby forming troughs at different positions on a frequency response curve of the loudspeaker 100.

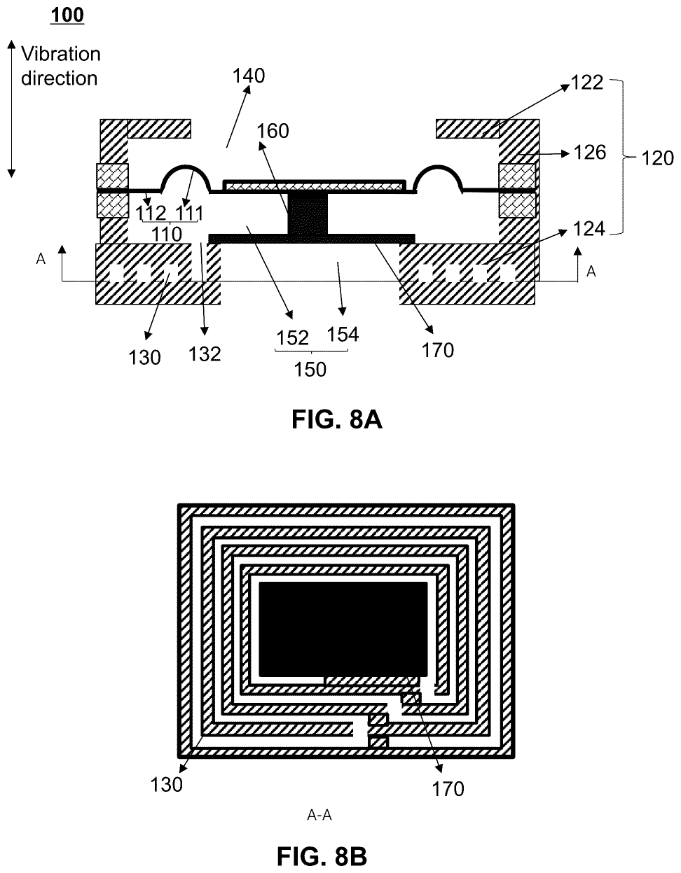

In some embodiments, the shape of a projection (or a cross-section along A-A) of the sound absorption pipe along a vibration direction of a vibration diaphragm may include a loop structure or a folded structure. As shown in FIG. 6B, a shape of the cross-section of the sound absorption pipe 130 along A-A may be a loop structure. In some embodiments, the loudspeaker further includes a driving unit, and on a projection plane along a vibration direction of the driving unit, the loop structure may be disposed around the driving unit. For example, the sound absorption pipe 130 may be provided on the side plate 126, and a shape of a cross-section of the sound absorption pipe 130 along A-A may be a loop structure surrounding the driving unit. As another example, the sound absorption pipe 130 may be provided on the front cavity plate 122 or the rear cavity plate 124, and the shape of a cross-section of the sound absorption pipe 130 may be a loop structure. A specific description of a positional relationship between the driving unit and the loop structure may be found in FIG. 8A, FIG. 8B and their related descriptions. As shown in FIG. 6C, a shape of the cross-section of the sound absorption pipe 130 along A-A may also be a folded structure. It is understood that without violating the principles in the embodiments of the present disclosure, the shape of the cross-section of the sound absorption pipe 130 along A-A may also be a W-shape, an S-shape, an irregular shape, or the like, which is not limited by the present disclosure.

In some embodiments, the more circles the loop structure wraps around the driving unit or the more times the folded structure is folded, the greater the equivalent length l of the sound absorption pipe. Correspondingly, the wavelength λ corresponding to the target frequency is larger, allowing the sound absorption pipe to absorb sound waves of a lower frequency. Through the loop structure and/or the folded structure, a sufficiently long sound absorption pipe may be provided in a limited space (i.e., in a structure of the front cavity plate 122, the rear cavity plate 124, the side plate 126, etc.), so that the sound absorption pipe may absorb sound waves of a lower target frequency, thus increasing the utility of the loudspeaker while ensuring the miniaturization of the volume of the loudspeaker.

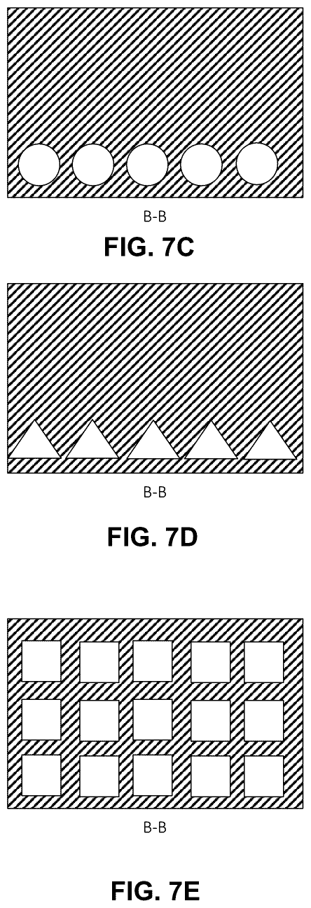

FIG. 7A is a schematic diagram illustrating an exemplary three-dimensional structure of a sound absorption pipe according to some embodiments of the present disclosure. FIG. 7B and FIG. 7E are schematic diagrams illustrating cross-sections of the sound absorption pipe in FIG. 7A along B-B.

In some embodiments, the sound absorption pipe 130 may include the sound absorption cavity 136 and the sound inlet hole 132, as shown in FIG. 7A. A dimension (e.g., the equivalent length/of the sound absorption pipe 130 and the equivalent diameter d of the sound absorption pipe 130), shape, etc., of the sound absorption pipe 130 may be configured to absorb sound waves of different target frequencies, thereby forming troughs at different positions on a frequency response curve of the loudspeaker 100.

Cross-sections shown in FIG. 7B to FIG. 7D may be cross-sections of the sound absorption pipe 130 when the cross-section of the sound absorption pipe 130 is a loop structure, a folded structure, or the like along A-A. In some embodiments, the shape of a cross-section of the sound absorption pipe 130 along B-B may include a plurality of rectangles, circles, and triangles disposed side-by-side. It will be appreciated that without violating the principles in the embodiments of the present disclosure, the shape of the cross-section of the sound absorption pipe 130 along B-B may also be an oval, a polygonal, an irregular shape, etc., which is not limited by the present disclosure.

In some embodiments, the sound absorption pipe may be disposed in layers along a vibration direction of a vibration diaphragm. As shown in FIG. 7E, a shape of a cross-section of the sound absorption pipe 130 along B-B may be a plurality of rectangles arranged in a plurality of layers. By arranging the sound absorption pipe in layers, a length of the sound absorption pipe may be further increased to further increase the utility of the loudspeaker while keeping the volume of the loudspeaker small.

FIG. 8A is a schematic diagram illustrating an exemplary structure of a loudspeaker according to some embodiments of the present disclosure. FIG. 8B is a schematic diagram illustrating a cross-section of the sound absorption pipe in FIG. 8A along A-A.

In some embodiments, the sound absorption pipe 130 may be disposed on the rear cavity plate 124 and is in flow communication with the first rear cavity 152 via the sound inlet hole 132, as shown in FIG. 8A. In some embodiments, the sound inlet hole 132 may be located within a projection of the vibration diaphragm 110 along a vibration direction of the vibration diaphragm 110. The sound absorption pipe 130 may reduce a sound pressure amplitude of air-conducted sound waves generated by the vibration diaphragm 110 at the sound inlet hole 132 such that the air near the vibration diaphragm 110 may be affected by the sound inlet hole 132. In such cases, the localized air in different portions of the vibration diaphragm 110 can be influenced by setting a position of the sound inlet hole 132, which can change the state of the vibration diaphragm 110, and thus making the vibration of the vibration diaphragm 110 more in line with the use requirements of the loudspeaker.

In some embodiments, the vibration diaphragm 110 may include the folded-ring portion 111 and the fixed end 112. In some embodiments, the sound inlet hole 132 may be provided at a location proximate to the folded-ring portion 111 of the vibration diaphragm 110. For example, the sound inlet hole 132 may face the folded-ring portion 111 of the vibration diaphragm 110. For example, a center of the sound inlet hole 132 may coincide with a center of the folded-ring portion 111 on a projection plane along the vibration direction of the vibration diaphragm 110. A portion of the vibration diaphragm 110 that is closer to the folded-ring portion 111 has smaller stiffness, and a portion of the vibration diaphragm 110 that is closer to the fixed end 112 has larger stiffness. Thus, the closer the sound inlet hole 132 is to an edge of the fixed end 112, the less the sound inlet hole 132 affects the vibration diaphragm 110; the closer the sound inlet hole 132 is to the middle of the folded-ring portion 111, the more the sound inlet hole 132 affects the vibration diaphragm 110. By setting the sound inlet hole 132 close to the folded-ring portion 111, the sound absorption pipe 130 may affect the localized air near the folded-ring portion 111, which is more likely to affect the vibration state of the vibration diaphragm 110, thus facilitating the adjustment of the acoustic performance of the loudspeaker 100. In some embodiments, when it is expected that the sound absorption pipe 130 has less influence on the vibration of the vibration diaphragm 110, the sound inlet hole 132 may be provided at a position near the fixed end 112 of the vibration diaphragm 110. By setting the sound inlet hole 132 at the position near the fixed end 112, the sound absorption pipe 130 may have less influence on the localized air near the folded-ring portion 111, thereby reducing the influence of the sound absorption pipe 130 on the vibration state of the vibration diaphragm 110 and realizing fine-tuning of the acoustic performance of the loudspeaker 100.

In some embodiments, a structure of the sound absorption pipe 130 may include a loop structure, as shown in FIG. 8B. On a projection plane along a vibration direction of the driving unit 170 (or the vibration diaphragm 110), the loop structure of the sound absorption pipe 130 is disposed around the driving unit 170, so that a longer sound absorption pipe may be provided in a limited space of the rear cavity plate 124, so that the sound absorption pipe 130 may absorb sound waves of a lower target frequency, thereby increasing the utility of the loudspeaker 100 while ensuring the miniaturization of the volume of the loudspeaker 100.

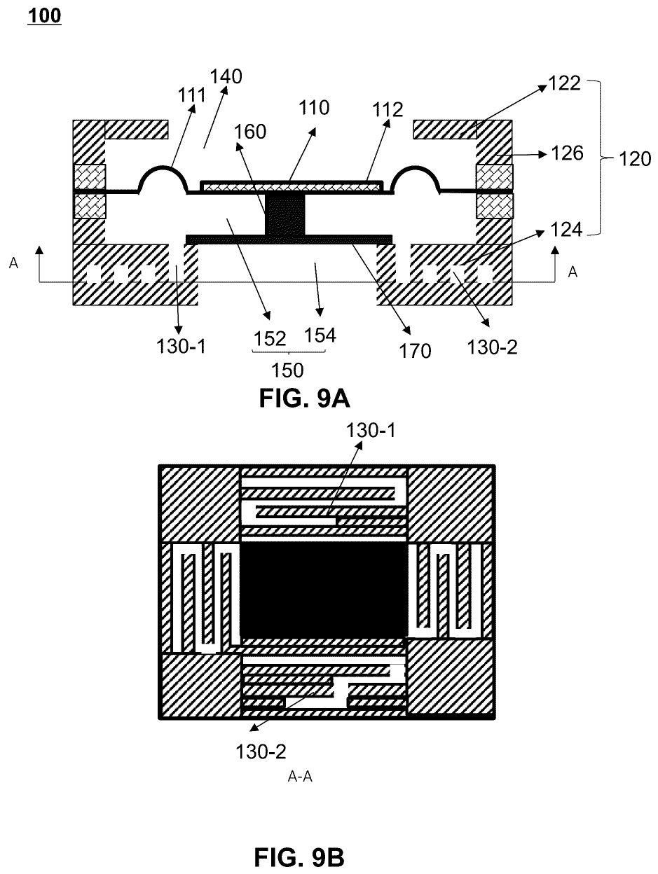

FIG. 9A is a schematic diagram illustrating an exemplary structure of a loudspeaker according to some other embodiments of the present disclosure. FIG. 9B is a schematic diagram illustrating a cross-section of the sound absorption pipe in FIG. 9A along A-A.

In some embodiments, the sound absorption pipe 130 may include sub-sound absorption pipes, and the sub-sound absorption pipes may be in flow communication with the front cavity 140 or the rear cavity 150, respectively, via a sound inlet hole. For example, the sound absorption pipe 130 may include a sub-sound absorption pipe 130-1 and a sub-sound absorption pipe 130-2, as shown in FIG. 9A and FIG. 9B. The sub-sound absorption pipe 130-1 and the sub-sound absorption pipe 130-2 are in flow communication with the first rear cavity 152 via a sound inlet hole, respectively. In some embodiments, at least two of the sub-sound absorption pipes may absorb sound waves of different frequencies in the air-conducted sound waves. For example, when sound waves of a plurality of target frequencies need to be absorbed, a length/of the sub-sound absorption pipe 130-1 and a length of the sub-sound absorption pipe 130-2 may be different so that the two sub-sound absorption pipes can absorb sound waves of different frequencies, increasing a sound absorption bandwidth of the sound absorption pipe 130, making a frequency response curve of the loudspeaker 100 flatter, thereby improving the sound quality of the loudspeaker 100. In some embodiments, at least two of the plurality of sub-sound absorption pipes may absorb sound waves of the same frequency in the air-conducted sound waves. For example, the length/of the sub-sound absorption pipe 130-1 and the length I of the sub-sound absorption pipe 130-2 may be the same so that the two sub-sound absorption pipes may absorb sound waves of a same frequency at different positions, thereby adjusting a vibration state of the vibration diaphragm 110 at different positions and improving the sound absorption effect of the sound absorption pipe 130.

In some embodiments, if a plurality of sub-sound absorption pipes are arranged at a localized position of the rear cavity plate 124, the sound absorption pipe 130 may locally affect a motion state of the vibration diaphragm 110, resulting in an imbalanced air stiffness in the rear cavity 150 (e.g., the first rear cavity 152), which makes the vibration diaphragm 110 tilted, resulting in the appearance of a resonance peak of a high-order mode on the frequency response curve of the loudspeaker 100, and lowering the acoustic output effect of the loudspeaker 100. To avoid the non-essential high-order mode of the loudspeaker 100, the plurality of sub-sound absorption pipes may be symmetrically (or approximately symmetrically) distributed along a center axis of the loudspeaker 100. For example, positions of the plurality of sub-sound absorption pipes (e.g., a position of the sound inlet hole) may be symmetrically (or approximately symmetrically) distributed along the center axis of the loudspeaker 100. As another example, shapes of the plurality of sub-sound absorption pipes may be symmetrically (or approximately symmetrically) distributed along the center axis of the loudspeaker 100. In addition, by arranging the plurality of sub-sound absorption pipes distributed symmetrically along the center axis of the loudspeaker 100, a structure of the rear cavity plate 124 (or the front cavity plate 122) may be more reliable, thereby extending the service of the loudspeaker 100. For example, as shown in FIG. 9A, the loudspeaker 100 may include the sub-sound absorption pipe 130-1 and the sub-sound absorption pipe 130-2, and the two sub-sound absorption pipes may be disposed on two sides along the center axis of the loudspeaker 100, respectively. Further, the two sub-sound absorption pipes may be disposed symmetrically around the center axis of the loudspeaker 100 on the rear cavity plate 124 and are in flow communication with the first rear cavity 152 via a sound inlet hole, respectively.

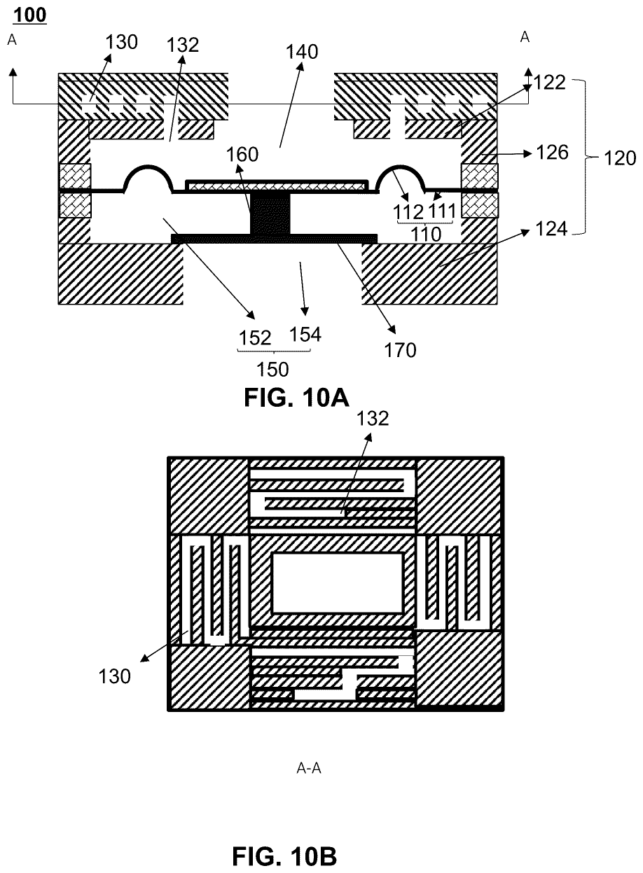

FIG. 10A is a schematic diagram of the structure of an exemplary loudspeaker according to some other embodiments of the present disclosure. FIG. 10B is a schematic diagram illustrating a cross-section of the sound absorption pipe in FIG. 10A along A-A.

In some embodiments, the sound absorption pipe 130 is disposed on the front cavity plate 122 and is in flow communication with the front cavity 140 via the sound inlet hole 132, as shown in FIG. 10A. Sound waves generated by the vibration diaphragm 110 may enter a sound absorption cavity of the sound absorption pipe 130 via the sound inlet hole 132. In some embodiments, the sound inlet hole 132 may be located within a projection of the vibration diaphragm 110 along a vibration direction of the vibration diaphragm 110. For example, the sound inlet hole 132 may face the folded-ring portion 111 of the vibration diaphragm 110. In some embodiments, as shown in FIG. 10A and FIG. 10B, the sound absorption pipe 130 provided in the front cavity plate 122 may include sub-sound absorption pipes. Specific descriptions of the sub-sound absorption pipe can be found in FIG. 9A, FIG. 9B, and their related descriptions, which will not be repeated herein.

In some embodiments, by providing the sound absorption pipe 130 in the front cavity plate 122, the sound absorption pipe 130 can not only affect the vibration state of the loudspeaker 100, but also directly absorb some of the air-conducted sound waves generated by the vibration of the vibration diaphragm 110, thereby affecting the acoustic performance of the loudspeaker 100. In the present disclosure, direct absorption refers to that since the sound absorption pipe 130 is in flow communication with the front cavity 140, the sound absorption pipe 130 may absorb sound waves of a target frequency when the air-conducted sound waves are transmitted to a sound outlet hole. Compared to the rear cavity plate 124, by providing the sound absorption pipe 130 in the front cavity plate 122, the sound absorption effect is more pronounced, so that the acoustic performance of the loudspeaker 100 can be directly affected, and this design is simpler and more convenient, which facilitates subsequent assembly. In some embodiments, the front cavity 140 may be in flow communication with the sound outlet hole via a sound guiding channel (not shown in the figures). The sound absorption pipe 130 may be in flow communication with the sound guiding channel through the front cavity 140. In other words, the sound absorption pipe 130 in the front cavity plate 122 may be directly in flow communication with the front cavity 140 and indirectly in flow communication with the sound outlet hole through the front cavity 140 and the sound guiding channel.

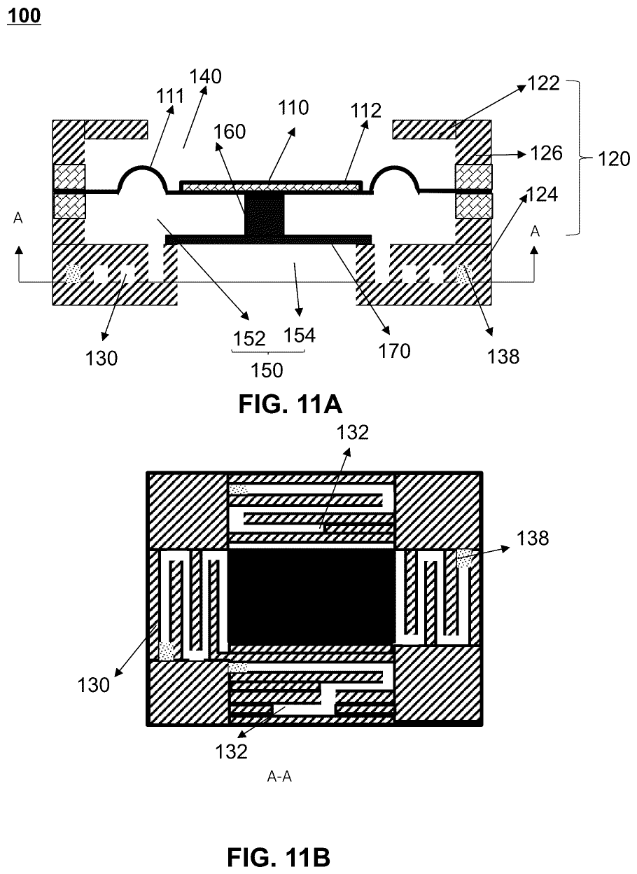

FIG. 11A is a schematic diagram illustrating an exemplary structure of a loudspeaker according to some other embodiments of the present disclosure. FIG. 11B is a schematic diagram illustrating a cross-section of the sound absorption pipe in FIG. 11A along A-A.

In some embodiments, a loudspeaker shown in FIG. 11A may be similar to the loudspeaker shown in FIG. 9A, with a difference being that the other end of the sound absorption pipe 130 of the loudspeaker 100 shown in FIG. 11A may also include a sound absorption structure 138. In some embodiments, the sound absorption structure includes at least one of a porous sound absorption material or a damping mesh. In some embodiments, the sound absorption structure 138 may change the phase difference on between the incident sound wave and the reflected sound wave at the sound wave reflection surface (i.e., the end of the sound absorbing pipe 130), thereby adjusting the length of the sound absorption pipe required at the same target frequency. For example, the porous sound absorption material may increase an equivalent constant of the sound absorption pipe, and the damping mesh may be configured to adjust the damping of the sound absorption pipe 130, so that a length of the sound absorption pipe required at the same target frequency may be reduced. Additionally, the sound absorption structure 138 reduces the quality factor (i.e., Q-value) of the loudspeaker 100, thereby reducing a depth of a trough generated by the sound absorption pipe 130 and making a frequency response curve of the loudspeaker 100 flatter.

By providing the sound absorption structure 138 at the end of the sound absorption pipe 130 in the present embodiment, the length of the sound absorption pipe 130 is no longer the only factor for determining a target frequency, and for loudspeakers that are smaller in size and have narrow spaces for the installation of a relatively long sound absorption pipe, the sound absorption structure may be provided at the end of the sound absorption pipe in place of the relatively long sound absorption pipe, thereby improving the output effect of the loudspeaker.

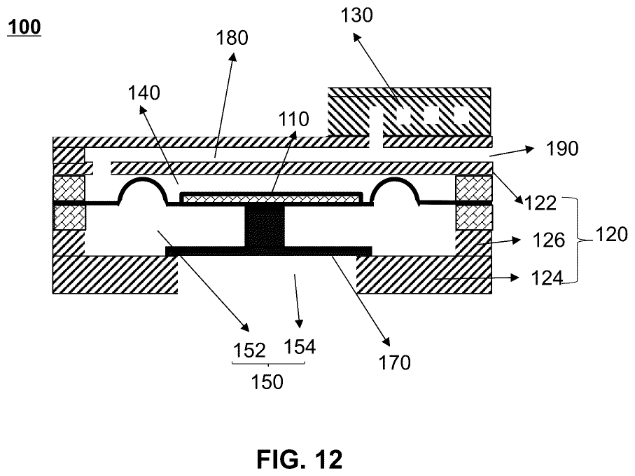

FIG. 12 is a schematic diagram illustrating an exemplary structure of a loudspeaker according to some embodiments of the present disclosure.

In some embodiments, the front cavity 140 of the casing 120 of a loudspeaker may be in flow communication with a sound outlet hole 190 through a sound guiding channel 180, as shown in FIG. 12. The sound absorption pipe 130 may be disposed within the sound guiding channel 180, i.e., the sound absorption pipe 130 may be in flow communication with the front cavity 140 through the sound guiding channel 180. In other words, the sound absorption pipe 130 is in flow communication with the sound outlet hole 190 only through the sound guiding channel 180. By providing the sound absorption pipe 130 in a sidewall of the sound guiding channel 180, the sound absorption pipe 130 is more concise and convenient for subsequent assembly. For example, different sound guiding channels provided with different sound absorption pipes may be used as accessories, and components other than the sound guiding channels assembled with sound absorption pipes may be used as base components. For a base component, different accessories may be assembled on the base component to achieve various adjustments of the frequency response of the loudspeaker, allowing the loudspeaker to adapt to different application scenarios.

The beneficial effects generated by the embodiments of the present disclosure include, but are not limited to: (1) by providing the sound absorption pipe on the casing of the loudspeaker, the trough is generated on the frequency response curve of the loudspeaker, so as to enable the loudspeaker to directly emit sound with adjusted frequency response, making the loudspeaker have a built-in structural filtering effect; (2) by adjusting the shape, position, size, etc. of the sound absorption pipe, the target frequency corresponding to the sound absorption pipe is the same as or similar to the original resonance frequency of the vibration diaphragm, thus making the frequency response curve of the loudspeaker flatter and improving the acoustic performance of the loudspeaker; (3) through the loop structure, folded structure, etc., the sound absorption pipe can absorb sound waves of a lower target frequency, so as to ensure the miniaturization of the volume of the loudspeaker and at the same time increase the utility of the loudspeaker; (4) by setting the sound absorption pipe in the front cavity plate and/or the rear cavity plate, and in combination with the damping mesh, the sound absorption material, etc., the frequency response curve of the loudspeaker is further flattened, thereby further enhancing the acoustic performance of the loudspeaker; (5) by setting a plurality of sub-sound absorption pipes to be symmetrically (or approximately symmetrically) distributed along the center axis of the loudspeaker, the reliability of the casing of the loudspeaker is improved with a saved space and lower processing cost of the loudspeaker. It should be noted that the beneficial effects that may be produced by different embodiments are different, and the beneficial effects that may be produced in different embodiments may be any one or a combination of any one or a combination of any of the foregoing, or any other beneficial effect that may be obtained.

The basic concepts have been described above, and it is apparent to those skilled in the art that the foregoing detailed disclosure serves only as an example and does not constitute a limitation of the present disclosure. Although not explicitly stated here, those skilled in the art may make various modifications, improvements and amendments to the present disclosure. These alterations, improvements, and modifications are intended to be suggested by the present disclosure, and are within the spirit and scope of the exemplary embodiments of the present disclosure.

What is claimed is:

1. A loudspeaker, comprising:
a vibration diaphragm, configured to vibrate to generate air-conducted sound waves; and
a casing, configured to form an accommodation cavity to accommodate the vibration diaphragm, the vibration diaphragm dividing the accommodation cavity into a front cavity and a rear cavity, the casing being provided with a sound outlet hole in flow communication with the front cavity, and at least a portion of the air-conducted sound waves being transmitted to the outside of the loudspeaker via the sound outlet hole, wherein
the casing is provided with a sound absorption pipe, and
the sound absorption pipe is in flow communication with at least one of the front cavity and the rear cavity and configured to absorb sound waves of a target frequency in the air-conducted sound waves, a length of the sound absorption pipe being in a range of 3/20-2/5 of a wavelength of the sound waves of the target frequency.

2. The loudspeaker of claim 1, wherein
vibration of the vibration diaphragm has an original resonance frequency, and
a difference between the original resonance frequency and the target frequency is within 300 Hz.

3. The loudspeaker of claim 1, wherein the target frequency is in a range of 3 kHz to 20 KHz.

4. The loudspeaker of claim 1, wherein
the front cavity is in flow communication with the sound outlet hole through a sound guiding channel, and
the sound absorption pipe is in flow communication with the sound guiding channel through the front cavity.

5. The loudspeaker of claim 1, wherein
the casing includes a front cavity plate, a rear cavity plate, and a side plate, and
an end of the sound absorption pipe includes a sound inlet hole.

6. The loudspeaker of claim 5, further including a driving unit configured to generate vibration based on an electrical signal and drive the vibration diaphragm to vibrate, wherein
the driving unit is provided in the rear cavity and cooperates with the rear cavity plate to divide the rear cavity into a first rear cavity and a second rear cavity, the second rear cavity being enclosed by the driving unit and the rear cavity plate.

7. The loudspeaker of claim 6, wherein the sound absorption pipe is provided in the rear cavity plate and in flow communication with the first rear cavity via the sound inlet hole.

8. The loudspeaker of claim 5, wherein the sound absorption pipe is provided in the front cavity plate and in flow communication with the front cavity via the sound inlet hole.

9. The loudspeaker of claim 5, wherein the other end of the sound absorption pipe is closed.

10. The loudspeaker of claim 5, wherein the sound inlet hole is located within a projection of the vibration diaphragm along a vibration direction of the vibration diaphragm.

11. The loudspeaker of claim 5, wherein
the vibration diaphragm includes a folded-ring portion and a fixed end, and
the sound inlet hole faces the folded-ring portion.

12. The loudspeaker of claim 1, wherein a projection of the sound absorption pipe along a vibration direction of the vibration diaphragm includes a loop structure or a folded structure.

13. The loudspeaker of claim 12, further including a driving unit, wherein
on a projection plane along a vibration direction of the driving unit, the loop structure is disposed around the driving unit.

14. The loudspeaker of claim 1, wherein
the sound absorption pipe includes sub-sound absorption pipes, and
each of the sub-sound absorption pipes is in flow communication with the front cavity or the rear cavity via a sound inlet hole.

15. The loudspeaker of claim 14, wherein the sub-sound absorption pipes are symmetrically disposed along a central axis of the loudspeaker.

16. The loudspeaker of claim 14, wherein at least two of the sub-sound absorption pipes absorb sound waves of a same frequency or different frequencies in the air-conducted sound waves.

17. The loudspeaker of claim 1, wherein an equivalent length of the sound absorption pipe is in a range of 4 mm to 28 mm.

18. The loudspeaker of claim 1, wherein an equivalent diameter of the sound absorption pipe is not less than 0.05 mm.

19. The loudspeaker of claim 1, wherein
the front cavity is in flow communication with the sound outlet hole through a sound guiding channel, and
the sound absorption pipe is provided on a side wall of the sound guiding channel and is in flow communication with the sound guiding channel via a sound inlet hole provided at one end of the sound absorption pipe.

20. The loudspeaker of claim 1, wherein the sound absorption pipe includes a 1/4 wavelength resonance tube.
